(19) United States
(12) Patent Application Publication
(10) Pub. No.: US 2012/0188175 A1
(43) Pub. Date: Jul. 26, 2012

(54) Single Finger Gesture Determination Method, Touch Control Chip, Touch Control System and Computer System

(76) Inventors: Yu-Tsung Lu, Hsinchu City (TW); Ching-Chun Lin, New Taipei City (TW); Jiun-Jie Tsai, Hsinchu City (TW); Tsen-Wei Chang, Taichung City (TW); Ting-Wei Lin, Hualien County (TW); Hao-Jan Huang, Hsinchu City (TW); Ching-Ho Hung, Hsinchu City (TW)

(21) Appl. No.: 13/104,029

(22) Filed: May 10, 2011

(30) Foreign Application Priority Data
Jan. 21, 2011 (TW) 100102252

(51) Int. Cl. G06F 3/041

(52) U.S. Cl. 345/173; 178/18.03

(57) ABSTRACT

A single finger gesture determination method is disclosed. The single touch gesture determination method includes steps of detecting one or more trigger signals, determining respective categories under a plurality of gesture groups to which the one or more trigger signals belong according to the one or more trigger signals, and deciding a finger gesture represented by the one or more trigger signals according to the determined respective categories under the plurality of gesture groups.

### BACKGROUND OF THE INVENTION

1. Field of the Invention

The present invention relates to a single finger gesture determination method, and more particularly, a single finger gesture determination method, touch control chip, touch control system and computer system utilizing the same, capable of simply determining various single finger gestures by using simple, common categorizing criteria.

2. Description of the Prior Art

Generally, touch sensing devices such as capacitive, resistive and other types of touch sensing devices, are capable of generating detecting signals related to a user's touch event to a touch sensing chip; the chip then compares the signal values of the detecting signals with threshold values to determine a touch point, and in turn, a gesture, according to the results. In the example of capacitive touch sensing devices, touch events are determined by detecting the capacitance difference generated when the human body touches a touch point on the touch panel; in other words, capacitive touch sensing is implemented through determining a touch point, and in turn, a touch event, by detecting the variations in capacitance characteristics when the human body touches the touch point.

Specifically, please refer to FIG. 1, which illustrates a conventional projected capacitive touch sensing device 10. The projected capacitive touch sensing device 10 includes sensing capacitor strings X₁-Xₘ, Y₁-Yₙ; each sensing capacitor string is a one-dimensional structure formed by connecting a plurality of sensing capacitor in series. Conventional touch sensing methods resort to detecting the capacitance in each sensing capacitor string to determine whether a touch event occurs. The sensing capacitor strings X₁-Xₘ and Y₁-Yₙ are utilized to determine vertical and horizontal touch events, respectively. In the case of horizontal operations, assume the sensing capacitor string X₁ has Q sensing capacitors, each sensing capacitor with a capacitance of C, then under normal circumstances, the sensing capacitor string X₁ has a capacitance of QC; and when the human body (e.g. a finger) comes in contact with a sensing capacitor of the sensing capacitor string X₁, assume the difference in capacitance is ΔC. It follows that, if the capacitance of the sensing capacitor string X₁ is detected to be greater than or equal to a predefined value (e.g. QC+ΔC), it can be inferred that the finger is touching a certain point on the sensing capacitor string X₁. Likewise, the similar may be asserted for vertical operations. As illustrated in FIG. 1, when the finger touches a touch point TP₁ (i.e. coordinates (X₃, Y₃)), the capacitance in the sensing capacitor strings X₃ and Y₃ concurrently varies, and it may be determined that the touch point falls at the coordinates (X₃, Y₃). Notice, however, that the threshold capacitance of the sensing capacitor strings X₁-Xₘ, for determining vertical directions, and the threshold capacitance of the sensing capacitor strings Y₁-Yₙ, for determining horizontal directions, do not necessarily have to be the same, depending on the practical requirement.

As can be seen from the above, the touch control chip compares signal values of the detecting signals generated by the touch sensing device with predefined threshold values; thus, it is possible to determine positions of all touch points and continuous occurrence times from start to end of a touch event, and in turn, to determine a gesture. Specifically, please refer to FIG. 2, which is a schematic diagram of conventional time conditions for determining a single click gesture, a drag gesture and a double click gesture. As shown in FIG. 2, during continuous occurrence times T1 and T3, the signal values of the detecting signals are at a finger-in level, i.e. the object is touching the touch sensing device; and during a stop occurrence time T2, the signal values of the detecting signals are at a finger-out level, i.e. the object leaves the touch sensing device. In other words, the object touches the touch sensing device twice, each time for a duration of the continuous occurrence times T1 and T3, respectively; the stop occurrence time T2 is a time interval between the two times the object touches the touch sensing device.

Under the aforementioned setting, the time conditions for determining single click gestures, drag gestures and double click gestures according to the prior art are as follows:
(1) Determine a single click gesture occurs if the continuous occurrence time T1 is longer than a reference time T1_{ref}.
(2) Determine a drag gesture occurs if the continuous occurrence time T1 is longer than the reference time T1_{ref}, the stop occurrence time T2 is shorter than a reference time T2_{ref} and the continuous occurrence time T3 is longer than a reference time T3_{ref}.
(3) Determine a double click gesture occurs if the continuous occurrence time T1 is longer than the reference time T1_{ref}, the stop occurrence time T2 is shorter than the reference time T2_{ref} and the continuous occurrence time T3 is shorter than the reference time T3_{ref}.

However, as can be seen from the above, determining single finger gestures such as single click gestures, drag gestures and double click gestures, etc, according to the prior art requires detecting the three time durations, i.e. the continuous occurrence times T1, T3 and the stop occurrence time T2, then comparing each time duration with the reference times T1_{ref}, T2_{ref}, T3_{ref}, followed by determining a single finger gesture according to different time conditions. In other words, the conventional single finger gesture determination methods not only require detecting a considerable quantity of time parameters, and it is also incapable of determining different single finger gestures by using a common method. Moreover, additional distance parameters need to be further detected for determining other types of single finger gestures, e.g. flip gestures, jump gestures, etc, leading to complicated calculations. Thus, it is necessary to improve the conventional techniques so as to achieve a simple determination process that is also capable of employing common determination criteria for various single finger gestures.

### SUMMARY OF THE INVENTION

Therefore, one of the primary objectives of the disclosure is to provide a single finger gesture determination method, a touch control chip and a touch control system and computer system utilizing the same, which are capable of simply determining various single finger gestures by using common categorizing criteria.

In an aspect, a single finger gesture determination method for a touch control chip is disclosed. The single finger gesture determination method includes detecting one or more trigger signals; determining respective categories under a plurality of gesture groups to which the one or more trigger signals belong according to the one or more trigger signals; and deciding a single finger gesture represented by the one or more trigger signals according to the determined respective categories under the plurality of gesture groups.

In another aspect, a touch control chip for a touch control system is disclosed. The touch control chip includes a detection unit for detecting one or more trigger signals; and a determining unit, for determining respective categories under a plurality of gesture groups to which the one or more trigger signals belong according to the one or more trigger signals, and deciding a single finger gesture represented by the one or more trigger signals according to the determined respective categories under the plurality of gesture groups.

Furthermore, in yet another aspect, a touch control system for determining single click gestures is further disclosed. The touch control system includes a touch sensing device for generating one or more signal values of one or more detecting signals; and the aforementioned touch control chip.

Furthermore, another embodiment further discloses a computer system, including a host; and the aforementioned touch control system, for determining single click gestures.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional projected capacitive touch sensing device.

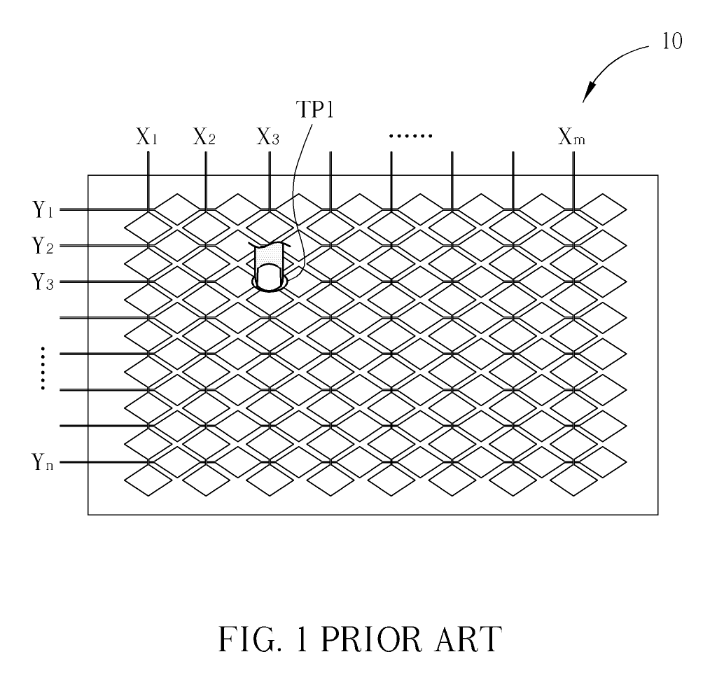

FIG. 2 is a schematic diagram of conventional time conditions for determining a single click gesture, a drag gesture and a double click gesture.

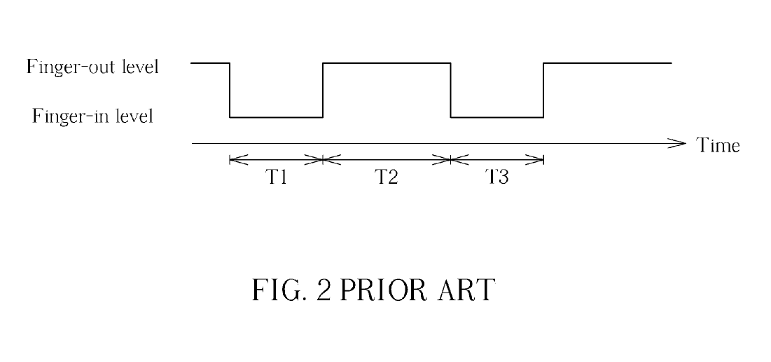

FIG. 3 is a functional block diagram of a computer system according to an embodiment.

FIG. 4A is a schematic diagram of determination of a single finger gesture STG by a touch control chip according to an embodiment.

FIG. 4B is a schematic diagram of a single click gesture determination process according to an embodiment.

FIGS. 5A-5C are schematic diagrams of a touch control chip of FIG. 3 determining a single finger gesture to be a single click gesture or a flip gesture, a drag gesture and a single click gesture or a flip gesture, respectively, according to an embodiment.

FIG. 6 is a schematic diagram of a single finger gesture determination process according to an embodiment.

### DETAILED DESCRIPTION

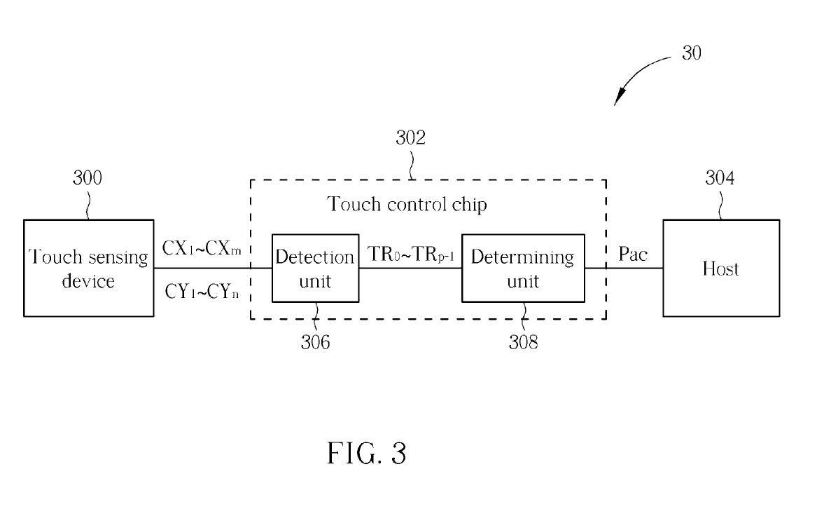

Please refer to FIG. 3, which is a functional block diagram of a computer system 30 according to an embodiment. As can be seen in FIG. 3, the computer system 30 mainly includes a touch sensing device 300, a touch control chip 302 and a host 304, wherein the touch sensing device 300 and the touch control chip 302 constitute a touch control system.

The touch sensing device 300 is capable of sensing an object to be detected (e.g. a finger, a pen, etc) and generating one or more detecting signals indicating a position of the object to be detected on a detecting panel (not shown). The touch control chip 302 includes a detection unit 306 and a determining unit 308. The detection unit 306 can compare one or more signal values of the one or more detecting signals with one or more threshold values, to obtain P trigger signals TR₀-TRₚ₋₁. The P trigger signals TR₀-TRₚ₋₁ correspond to the touch points T₀-Tₚ₋₁, respectively, wherein each touch point may either be a leaving point (finger-out point) or an entering point (finger-in point), and P is an integer. The determining unit 308 in turn determines, according to the P trigger signals TR₀-TRₚ₋₁, respective categories under Q gesture groups G₁-G_{q} to which the P trigger signals TR₀-TRₚ₋₁ belong; then the determining unit 308 can decide a single finger gesture STG represented by the P trigger signals TR₀-TRₚ₋₁ according to the determined respective categories under the Q gesture groups G₁-G_{q}. Finally, the determining unit 308 can transmit a packet Pac representing the single finger gesture STG to the host 304.

The following detailed description is based on a capacitive touch control system for illustrative purposes, but can also be generalized to resistive or other types of touch control systems, and is not limited to this. A capacitive touch sensing device 300 generates capacitance signals CX₁-CXₘ, CY₁-CYₙ corresponding to sensing capacitor strings X₁-Xₘ, Y₁-Yₙ as detecting signals. The detection unit 306 compares the capacitance signals CX₁-CXₘ and CY₁-CYₙ with a vertical threshold value Cvt and a horizontal threshold value Cht, respectively, to detect the P trigger signals TR₀-TRₚ₋₁.

More specifically, the detection unit 306 determines the trigger signal TR₀ corresponding to a first entering touch point T₀ occurs if a capacitance signal of the capacitance signals CX₁-CXₘ is greater than the vertical threshold value Cvt and a capacitance of the capacitance signals CY₁-CYₙ is greater than the horizontal threshold value Cht. Additionally, after the trigger signal TR₀ occurs, the detection unit 306 continues comparing the capacitance signals CX₁-CXₘ, CY₁-CYₙ with the vertical threshold value Cvt and the horizontal threshold value Cht, respectively, to detect subsequent trigger signals TR₁-TRₚ₋₁. Note that, the vertical threshold value Cvt and the horizontal threshold value Cht may or may not be the same, depending on practical requirements.

The determining unit 308 determines respective categories under the Q gesture groups G₁-G_{q} (wherein Q is an integer) to which the P trigger signals TR₀-TRₚ₋₁ belong according to the P trigger signals TR₀-TRₚ₋₁, and then decides the single finger gesture STG represented the P trigger signals TR₀-TRₚ₋₁ according to the determined respective categories under the Q gesture groups G₁-G_{q}.

Specifically, the determining unit 308 first obtains a plurality of characteristic parameters according to the P trigger signals TR₀-TRₚ₋₁, e.g. a quantity characteristic parameter, a distance characteristic parameter, a direction characteristic parameter, etc. Next, the determining unit 308 decides the respective categories under Q gesture groups G₁-G_{q} according to the plurality of characteristic parameters. Preferably, the total quantity of the plurality of characteristic parameters is also Q, allowing the determining unit 308 to decide the respective categories under the Q gesture groups G₁-G_{q}, respectively. Next, the determining unit 308 decides the single finger gesture STG is a single finger gesture related to an intersection set of the respective categories under the Q gesture groups G₁-G_{q}. Finally, the determining unit 308 generates a packet Pac indicating the single click gesture STG to the host 304, so that the host 304 can operate according to the packet Pac. Related operations pertaining to determination of a touch point are similar to that of the projected capacitive touch sensing device 10, and thus not described here in further detail.

Take a case of Q=2 as an example, in which the determining unit 308 decides respective categories under two gesture groups G₁, G₂, respectively according to two characteristic parameters. A first group G₁ can be divided into different categories C₁₁-C₁ₐ (wherein a is an integer), each assigned to correspond to different parameter values of the first characteristic parameter. Thus, the determining unit 308 can decide exactly to which category among the categories C₁₁-C₁ₐ under the first group G₁ the P trigger signals TR₀-TRₚ₋₁ belong, according to an acquired parameter value of the first characteristic parameter, e.g. C₁ₓ (wherein x is an integer between 1 to a). Likewise, a second group G₂ can be divided into different categories C₂₁-C_{2b} (wherein b is an integer), each of which is assigned to correspond to different parameter values of the second characteristic parameter. Thus, the determining unit 308 can decide exactly to which category among the categories C₂₁-C_{2b} under the second group G₂ the P trigger signals TR₀-TRₚ₋₁ belong, according to an acquired parameter value of the second characteristic parameter, e.g. C_{2y} (wherein y is an integer between 1 to b). Moreover, a plurality of intersection sets are formed between the different categories C₁₁-C₁ₐ of the first group G₁ and the different categories C₂₁-C_{1b} of the second group G₂, wherein the intersection set are assigned to relate to different single finger gestures. Therefore, after deciding the category C₁ₓ and the category C_{2y}, the determining unit 308 can further decide the single finger gesture STG is a single finger gesture related to an intersection set between the category G₁ₓ and the category C_{2y}. The above descriptions may be analogized for applications with more gesture groups and more characteristic parameters.

Under such a configuration, the touch control chip 302 therefore needs only detect the P trigger signals TR₀-TRₚ₋₁, and then decide the respective categories C₁ₓ, C_{2y} . . . of the Q gesture groups G₁, G₂ . . . , according to the characteristic parameters, and finally decide the single finger gesture STG is a single finger gesture related to an intersection set between the categories C₁ₓ, C_{2y} . . . . Accordingly, the touch control chip 302 is capable of categorizing and determining different single finger gestures simply by using common determination criteria.

In a preferred embodiment, a quantity characteristic parameter of the P trigger signals TR₀-TRₚ₋₁ may represent a quantity of one or more subsequent touch points corresponding to subsequent trigger signals TR₁-TRₚ₋₁ except a first occurring trigger signal TR₀ within a reference time, wherein each of the one or more subsequent touch points may either be a leaving point or an entering point. In short words, the quantity characteristic parameter represents a quantity of leaving points and entering points within a reference time after a first entering point. Furthermore, in a preferred embodiment, a distance characteristic parameter of the P trigger signals TR₀-TRₚ₋₁ may be decided by one or more relative distances of the touch points corresponding to the trigger signals TR₀-TRₚ₋₁ (wherein each touch point may either be a leaving point or an entering point). More specifically, the one or more relative distances may, preferably, be decided to be relative distances, respectively from the one or more subsequent touch points (corresponding to the one or more subsequent trigger signals TR₁-TRₚ₋₁), to the first entering touch point (corresponding to the first occurring trigger signals TR₀).

Following are detailed descriptions of operations pertaining to determination of the single finger gesture by the touch control chip 302 of FIG. 3 for the case Q=2, wherein a quantity characteristic parameter and a distance characteristic parameter are employed as the plurality of characteristic parameters.

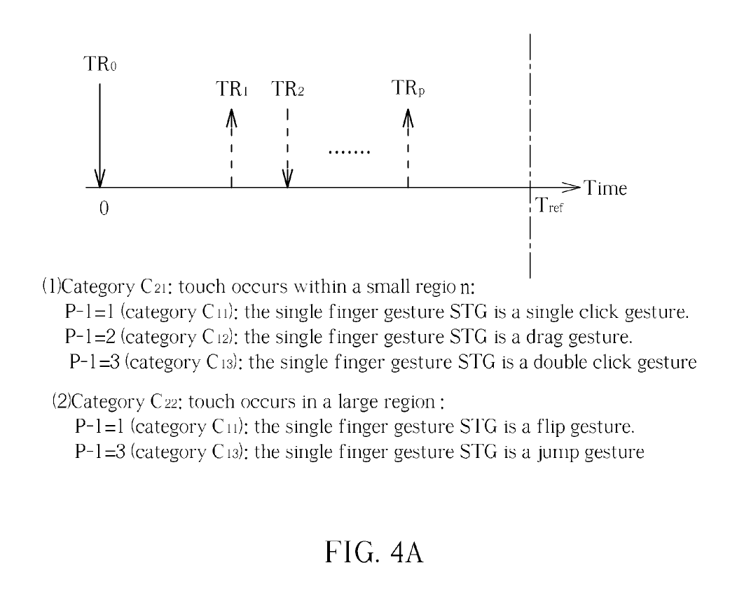

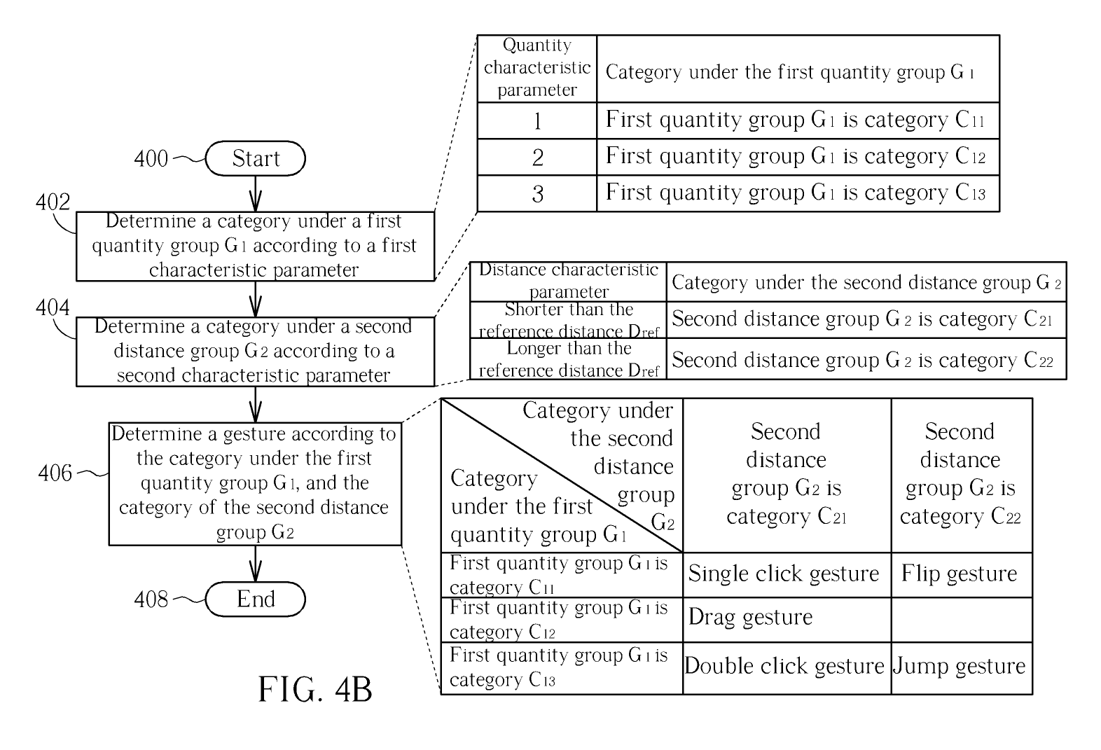

Please refer to FIG. 4A, which is a schematic diagram of the determination of the single finger gesture STG by the touch control chip 302 of FIG. 3 according to an embodiment. In FIG. 4A, a down arrow represents that the touch sensing device 300 starts being touched at a corresponding time point, i.e. corresponding to an entering point; and an up arrow represents that the touch sensing device 300 ends being touched at another corresponding time point, i.e. corresponding to a leaving point.

As shown in FIG. 4A, the touch control chip 302 detects a trigger signal TR₀ (corresponding to a first entering touch point T₀) occurs at time point t=0, and it also detects a quantity of P−1 subsequent trigger signals TR₁-TRₚ₋₁ (corresponding to one or more subsequent touch point T₁-Tₚ₋₁, respectively) within a reference time T_{ref}, so it takes P−1 as the quantity characteristic parameter. Moreover, the touch control chip 302 takes the relative distances, from the first entering touch point T₀ (corresponding to the trigger signals TR₀), respectively to the one or more subsequent touch points T₁-Tₚ₋₁ (corresponding to the one or more subsequent trigger signals TR₁-TRₚ₋₁, respectively), as the distance characteristic parameter.

Next, when the quantity characteristic parameter P−1 indicates a quantity of the subsequent trigger signals TR₁-TRₚ₋₁ within the reference time T_{ref} is 1, 2, and 3, the touch control chip 302 decides the P trigger signals TR₀-TRₚ₋₁ to belong respectively to first to third quantity categories C₁₁-C₁₃ under a quantity group G₁ among the Q gesture groups G₁-G_{q}. Moreover, when the distance characteristic parameter indicates the distances respectively from the P−1 subsequent touch points T₁-Tₚ₋₁ to the first entering touch point T₀ are all shorter than a reference distance D_{ref}, the touch control chip 302 further decides that the P trigger signals TR₀-TRₚ₋₁ to belong to a first distance category C₂₁ under a distance group G₂ among the Q gesture groups G₁-G_{q}; otherwise, the touch control chip 302 decides the P trigger signals TR₀-TRₚ₋₁ to belong to a second distance category C₂₂ under the distance group G₂.

Finally, the touch control chip 302 can decide the single finger gesture STG is a single finger gesture related to an intersection set between the respective category of the quantity group G₁ and the respective category under the distance group G₂. The deciding is performed as follows:

(1) Category C₂₁: touch occurs within a small region:

P−1=1 (category C₁₁): the single finger gesture STG is a single click gesture.

P−1=2 (category C₁₂): the single finger gesture STG is a drag gesture.

P−1=3 (category C₁₃): the single finger gesture STG is a double click gesture.

(2) Category C₂₂: touch occurs in a large region:

P−1=1 (category C₁₁): the single finger gesture STG is a flip gesture.

P−1=3 (category C₁₃): the single finger gesture STG is a jump gesture.

Aforementioned operations in FIG. 4A can be summarized into a single click gesture determination process 40, as shown in the embodiment of FIG. 4B. The process 40 includes following steps:

Step 400: Start.

Step 402: Determine a category under a first quantity group G₁ according to a first characteristic parameter.

Step 404: Determine a category under a second distance group G₂ according to a second characteristic parameter.

Step 406: Determine a gesture according to the category under the first quantity group G₁, and the category under the second distance group G₂.

Step 408: End.

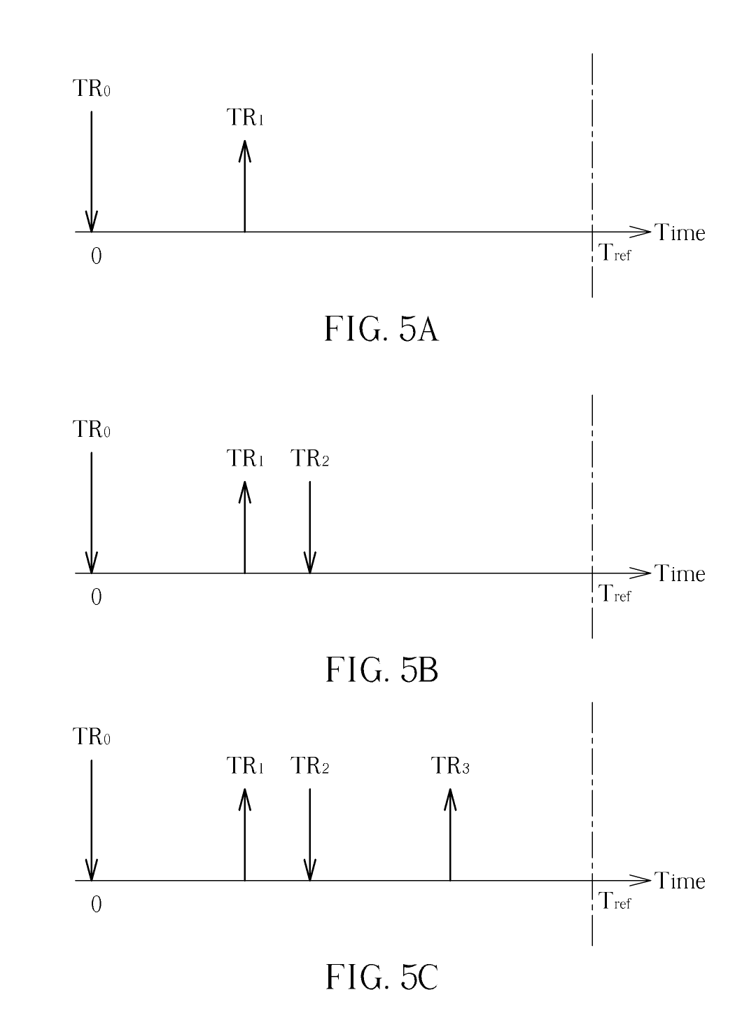

FIGS. 5A-5C illustrate various single finger gestures of the single finger gesture STG in the aforementioned embodiment. Please refer to FIG. 5A, which is a schematic diagram of the touch control chip 302 in FIG. 3 determining the single finger gesture STG to be a single click gesture or a flip gesture according an embodiment. As shown in FIG. 5A, the touch control chip 302 detects the trigger signal TR₀ (corresponding to the first entering touch point T₀) occurs at time t=0, and detects only one subsequent trigger signal TR₁ (corresponding to a leaving point T₁), within the reference time T_{ref}. The touch control chip 302 can first decide the P trigger signals TR₀-TRₚ₋₁ to belong to the first quantity category C₁₁ under the quantity group G₁. Next, if a distance between the leaving point T₁ and the first entering touch point T₀ is shorter than the reference distance D_{ref}, the touch control chip 302 can decide the P trigger signals TR₀-TRₚ₋₁ to belong to the first distance category C₂₁ under the distance group G₂; in turn the touch control chip 302 can decide that the single finger gesture STG is a single click gesture related to an intersection set between the categories C₁₁ and C₂₁, i.e. a conventional single click gesture, in which the touch leaves within a small region. In contrast, if the distance between the leaving point T₁ and the first entering touch point T₀ is longer than the reference distance D_{ref}, the touch control chip 302 can decide the P trigger signals TR₀-TRₚ₋₁ to belong to the second distance category C₂₂ under the distance group G₂, and in turn the touch control chip 302 can decide that the single finger gesture STG is a flip gesture related to an intersection set between the categories C₁₁, C₂₂, i.e. a conventional flip gesture, in which the touch moves a certain distance before leaving.

Please refer to FIG. 5B, which is a schematic diagram of the touch control chip 302 in FIG. 3 determining the single finger gesture STG to be a drag gesture according an embodiment. As shown in FIG. 5B, in another embodiment, the touch control chip 302 detects the trigger signal TR₀ (corresponding to the first entering touch point T₀) occurs at time t=0, and detects only two subsequent trigger signals TR₁, TR₂ (corresponding to a leaving point T₁ and an entering point T₂) within the reference time T_{ref}. The touch control chip 302 can first decide the P trigger signals TR₀-TRₚ₋₁ to belong to the second quantity category C₁₂ under the quantity group G₁. In contrast, if the distances between the first entering touch point T₀ and both the leaving point T₁ and the touch point T₂ are shorter than the reference distance D_{ref}, the touch control chip 302 can decide the P trigger signals TR₀-TRₚ₋₁ to belong to the first distance category C₂₁ under the distance group G₂, and in turn it can decide that the single finger gesture STG is a drag gesture related to the intersection set between the categories C₁₂ and C₂₁, i.e. a conventional drag gesture in which a touch first occurs within a small region for confirmation, then another touch occurs to commence the dragging movement.

Please refer to FIG. 5C, which is a schematic diagram of the touch control chip 302 in FIG. 3 determining the single finger gesture STG to be a double click gesture or a jump gesture according an embodiment. As shown in FIG. 5C, in a first embodiment, the touch control chip 302 detects trigger signal TR₀ (corresponding to the first entering touch point T₀) occurs at time t=0, and detects only three subsequent trigger signals TR₁, TR₂ and TR₃ (corresponding to a leaving point T₁, an entering point T₂ and a leaving point T₃, respectively) within the reference time T_{ref}. The touch control chip 302 can first decide the P trigger signals TR₀-TRₚ₋₁ to belong to the third quantity category C₁₃ under the quantity group G₁. Next, if all distances between the leaving point T₁, the entering point T₂, the leaving point T₃ and the first entering touch point T₀ are shorter than the reference distance D_{ref}, then the touch control chip 302 can decide the P trigger signals TR₀-TRₚ₋₁ to belong to the first distance category C₂₁ under the distance group G₂, and in turn it can decide that the single finger gesture STG is a double click gesture related to the intersection set between the categories C₁₃, C₂₁, i.e. a conventional double click gesture in which the touch occurs within a small region then leaves, then touches again and leaves. In contrast, if all distances between the leaving point T₁, the entering point T₂, the leaving point T₃ and the first entering touch point T₀ are longer than the reference distance D_{ref}, the touch control chip 302 can decide the P trigger signals TR₀-TRₚ₋₁ to belong to the second distance category C₂₂ under the distance group G₂, and in turn it can decide that the single finger gesture STG is a jump gesture related to the intersection set between the categories C₁₃ and C₂₂, i.e. a conventional jump gesture which touches a point and leaves, then touches another point at a certain distance away, then leaves.

Note that, the aforementioned reference distance D_{ref} merely serves as a distance determination parameter for determining gestures, and may be adjusted according to practical requirements. For example, if the touch sensing device 300 is mainly used for receiving single finger touch gestures within small regions, e.g. single click gestures, drag gestures, double click gestures, etc, then the reference distance D_{ref} may be assigned to be a larger value; if it is mainly used for receiving single finger touch gesture in large regions, e.g. flip gestures, jump gestures, etc, then the reference distance D_{ref} may be assigned to be a smaller value, to facilitate determination of the single finger gesture STG. The aforementioned reference time T_{ref} may also be accordingly adjusted to facilitate user operation and single finger gesture determination.

Note that, the single finger gesture STG determination method and related descriptions in the aforementioned embodiment only serve illustrative purposes, and practical implementations are not limited to the aforementioned, so long as the touch control chip 302 is capable of deciding the respective categories under the Q gesture groups G₁-G_{g} according to only the P trigger signals TR₀-TRₚ₋₁ and their characteristic parameters (e.g. quantity, distance, direction, etc) without changing original definitions of the single finger gesture or operations of the host 304, then deciding a single finger gesture STG to be a single finger gesture related to an intersection set of the respective categories accordingly, thus allowing simple determination for various single finger gestures by using common criteria. Those with ordinary skills in the art can make modifications or alterations accordingly, not limited to the determination methods and operations described in FIGS. 4A, and 5A-5C.

For example, the aforementioned touch control chip 302 first determines a category under the quantity group G₁ according to the quantity of the P−1 subsequent trigger signals TR₁-TRₚ₋₁ within the reference time T_{ref}, then determines a category under the distance group G₂ according to the relative positions of the touch points T₀-Tₚ₋₁ corresponding to the trigger signals TR₀-TRₚ₋₁, and finally decides a single finger gesture STG is the single finger gesture related to an intersection set of the determined categories. In practice, the touch control chip 302, however, may alternatively first determine a category under the distance group G₂ according to the relative positions of the touch points T₀-Tₚ₋₁ corresponding to the trigger signals TR₀-TRₚ₋₁, then determine a category under the quantity group G₁ according to the quantity of the P−1 subsequent trigger signals TR₁-TRₚ₋₁ within the reference time T_{ref}, and finally decide the single finger gesture STG according to the intersection set, without limitations to any specific determination sequence. Moreover, the aforementioned embodiment takes the case with the quantity of the trigger signals P having values 1 to 3 as an example, while in practice other values of the quantity P can also be used to categorize other single finger gestures for the single finger gesture STG, and are not limited thereto. Furthermore, the touch control chip 302 can also define categories for other gesture groups according to other characteristic parameters of the P trigger signals TR₀-TRₚ₋₁, e.g. touch pressure, direction, etc, to decide the single finger gesture STG is the single finger gesture related to the intersection set, without limitations to any specific quantity or type of the characteristic parameters.

In an embodiment, after the touch control chip 302 determines the single finger gesture STG is a flip gesture related to the intersection set between categories C₁₁ and C₂₂, it may further determine a moving direction for the gesture according to coordinates of the leaving point T₁ and the first entering touch point T₀, and then categorize a direction group G₃ into first to fourth direction categories C₃₁-C₃₄, and finally decide the single finger gesture STG is a left, right, up or down flip gesture that are related to intersection sets between the direction categories C₃₁-C₃₄, respectively, and the categories C₁₁, C₂₂.

In another embodiment, a same category intersection set can correspond to different single click gestures when the host 304 is operating under different modes. For example, when the host 304 is operating under a reading mode for an electronic book, if the touch control chip 302 detects that a distance between a leaving point T₁ and a first entering touch point T₀ corresponding to one subsequent trigger signal TR₁ within the reference time T_{ref} is longer than the reference distance D_{ref}, it can then determine that the single finger gesture STG is a flip gesture related to the intersection set between the categories C₁₁ and C₂₂. However, if the host 304 is operating under a window mode, then the touch control chip 302 alternatively determines the single finger gesture STG is a slide gesture related to the intersection set between the categories C₁₁ and C₂₂, instead, i.e. a conventional slide gesture in which a touch occurs then leaves after moving a cursor by a certain distance.

In practice, the host 304 may also carry out different operations for a same category intersection set when operating under different modes. For instance, if the host 304 is operating under a window mode and receives a packet Pac indicating the single finger gesture STG is a slide gesture, it only moves the cursor by a corresponding distance; however, if the host 304 first receives a packet Pac indicating the single finger gesture STG is a drag gesture while the cursor is on an object, the host 304 starts operating in a drag mode, in which it would further move the object by the corresponding distance after receiving a packet Pac indicating the single finger gesture STG is a slide gesture.

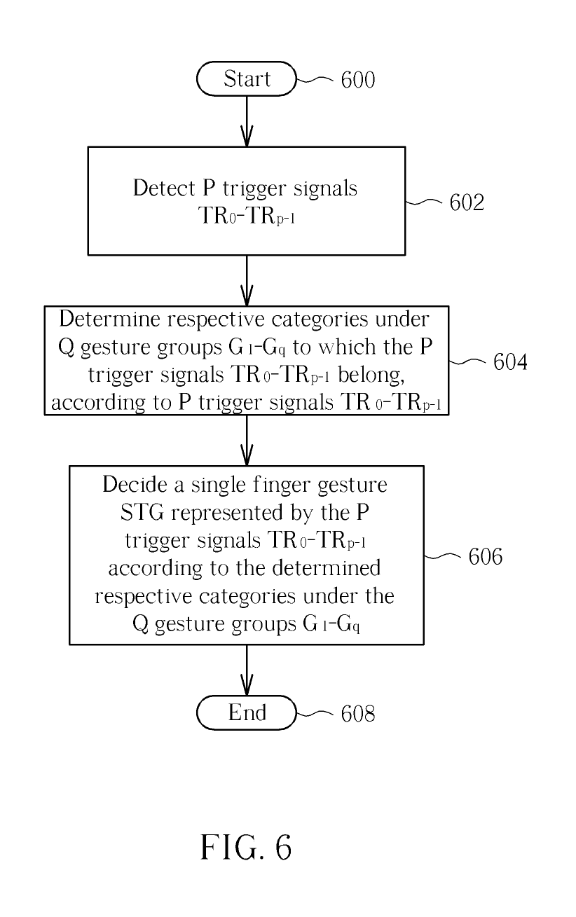

The single finger gesture determination method according to each aforementioned embodiment may be summarized into a single finger gesture determine process 60, as shown in FIG. 6, including following steps:

Step 600: Start.

Step 602: Detect P trigger signals TR₀-TRₚ₋₁.

Step 604: Determine respective categories under Q gesture groups G₁-G_{q} to which the P trigger signals TR₀-TRₚ₋₁ belong, according to P trigger signals TR₀-TRₚ₋₁.

Step 606: Decide a single finger gesture STG represented by the P trigger signals TR₀-TRₚ₋₁ according to the determined respective categories under the Q gesture groups G₁-G_{q}.

Step 608: End.

Details for each step may be derived from operations of each corresponding part of the touch control chip 302, and not iterated here.

In summary, the prior art requires detecting time parameters corresponding to a plurality of time durations under different touch scenarios, followed by comparing each with corresponding time parameters, respectively, thereby determining different single finger gestures according to different time conditions. Thus, the prior art not only requires detecting a considerable quantity of time parameters, it is incapable of determining all single finger gestures by using a common method; moreover, in case of an addition of distance parameters, calculations for determining single finger gestures would become immensely over-complicated. Comparatively, the aforementioned embodiments can detect one or more trigger signals, and decide respective categories under one or more gesture groups according to one or more characteristic parameters (e.g. quantity, distance, direction, etc) of the trigger signals, to determine a single finger gesture related to an intersection set of the categories, without changing original definitions of the single finger gesture or operations of the host. Thus the aforementioned embodiments are capable of categorizing and determining different single finger gestures in a simple way by using common criteria.

Those skilled in the art will readily observe that numerous modifications and alterations of the device and method may be made while retaining the teachings of the invention.

What is claimed is:

1. A single finger gesture determination method, comprising:
detecting one or more trigger signals;
determining respective categories under a plurality of gesture groups to which the one or more trigger signals belong according to the one or more trigger signals; and
deciding a single finger gesture represented by the one or more trigger signals according to the determined respective categories under the plurality of gesture groups.

2. The single finger gesture determination method of claim 1, wherein the step of deciding the single finger gesture comprises:
deciding the single finger gesture is a single finger gesture related to an intersection set of the respective categories under the plurality of gesture groups.

3. The single finger gesture determination method of claim 1, wherein the step of determining the respective categories under the plurality of gesture groups to which the one or more trigger signals belong comprises:
obtaining a plurality of characteristic parameters according to the one or more trigger signals; and
determining the respective categories under the plurality of gesture groups according to the plurality of characteristic parameters, respectively.

4. The single finger gesture determination method of claim 3, wherein the plurality of characteristic parameters comprise one or more of a quantity characteristic parameter, a distance characteristic parameter and a direction characteristic parameter.

5. The single finger gesture determination method of claim 4, wherein the quantity characteristic parameter represents a quantity of one or more subsequent touch points corresponding to subsequent trigger signals except a first occurring trigger signal in the one or more trigger signals within a reference time.

6. The single finger gesture determination method of claim 4, wherein the distance characteristic parameter is decided by one or more relative distances of one or more touch points corresponding to the one or more trigger signals.

7. The single finger gesture determination method of claim 6, wherein the one or more relative distances are respective relative distances of one or more subsequent touch points corresponding to one or more subsequent trigger signals except a first occurring trigger signal in the one or more trigger signals, to a first entering touch point corresponding to the first occurring trigger signal.

8. The single finger gesture determination method of claim 3, wherein the plurality of characteristic parameters are a quantity characteristic parameter and a distance characteristic parameter; and
the step of determining the respective categories under the plurality of gesture groups according to the plurality of characteristic parameters, respectively, comprises:
deciding a quantity group of the plurality of gesture groups is a first quantity category to a third quantity category, respectively, if the quantity characteristic parameter indicates a quantity of one or more subsequent touch points corresponding to one or more subsequent trigger signals except a first occurring trigger signal in the one or more trigger signals is 1 to 3; and
deciding a distance group of the plurality of gesture groups is a first distance category if the distance characteristic parameter indicates all relative distances of the one or more subsequent touch points to a first entering touch point corresponding to a first occurring trigger signal of the trigger signals are shorter than a reference distance, otherwise deciding the distance group is a second distance category.

9. The single finger gesture determination method of claim 8, wherein the step of deciding the single finger gesture represented by the one or more trigger signals according to the determined respective categories under the plurality of gesture groups comprises:
deciding the single finger gesture is a single click gesture if the quantity group is the first quantity category and the distance group is the first distance category.

10. The single finger gesture determination method of claim 8, wherein the step of deciding a single finger gesture represented by the one or more trigger signals according to the determined respective categories under the plurality of gesture groups comprises:
deciding the single finger gesture is a drag gesture if the quantity group is the second quantity category and the distance group is the first distance category.

11. The single finger gesture determination method of claim 8, wherein the step of deciding a single finger gesture represented by the one or more trigger signals according to the determined respective categories under the plurality of gesture groups comprises:
deciding the single finger gesture is a double click gesture if the quantity group is the third quantity category and the distance group is the first distance category.

12. The single finger gesture determination method of claim 8, wherein the step of deciding a single finger gesture represented by the one or more trigger signals according to the determined respective categories under the plurality of gesture groups comprises:
deciding the single finger gesture is a flip gesture if the quantity group is the first quantity category and the distance group is the second distance category.

13. The single finger gesture determination method of claim 8, wherein the step of deciding a single finger gesture represented by the one or more trigger signals according to the determined respective categories under the plurality of gesture groups comprises:
deciding the single finger gesture is a jump gesture if the quantity group is the third quantity category and the distance group is the second distance category.

14. A touch control chip, comprising:
a detection unit, for detecting one or more trigger signals; and
a determining unit, for determining respective categories under a plurality of gesture groups to which the one or more trigger signals belong according to the one or more trigger signals, and deciding a single finger gesture represented by the one or more trigger signals according to the determined respective categories under the plurality of gesture groups.

15. The touch control chip of claim 14, wherein the determining unit decides the single finger gesture is a single finger gesture related to an intersection set of respective categories under the plurality of gesture groups.

16. The touch control chip of claim 14, wherein the determining unit obtains a plurality of characteristic parameters according to the one or more trigger signals, and determines the respective categories under the plurality of gesture groups according to the plurality of characteristic parameters, respectively.

17. The touch control chip of claim 16, wherein the plurality of characteristic parameters comprise one or more of a quantity characteristic parameter, a distance characteristic parameter and a direction characteristic parameter.

18. The touch control chip of claim 17, wherein the quantity characteristic parameter represents a quantity of one or more subsequent touch points corresponding to subsequent trigger signals except a first occurring trigger signal in the one or more trigger signals within a reference time.

19. The touch control chip of claim 17, wherein the distance characteristic parameter is decided by one or more relative distances of one or more touch points corresponding to the one or more trigger signals.

20. The touch control chip of claim 19, wherein the one or more relative distances are the respective relative distances of one or more subsequent touch points corresponding to one or more subsequent trigger signals except a first occurring trigger signal in the one or more trigger signals, to a first entering touch point corresponding to the first occurring trigger signal.

21. The touch control chip of claim 16, wherein
the plurality of characteristic parameters are a quantity characteristic parameter and a distance characteristic parameter; and
the determining unit decides a quantity group of the plurality of gesture groups is a first quantity category to a third quantity category, respectively, if the quantity characteristic parameter indicates a quantity of one or more subsequent touch points corresponding to one or more subsequent trigger signals except a first occurring trigger signal in the one or more trigger signals is 1 to 3; the determining unit decides a distance group of the plurality of gesture groups is a first distance category if the distance characteristic parameter indicates all relative distances of the one or more subsequent touch points to a first entering touch point corresponding to a first occurring trigger signal of the trigger signals are shorter than a reference distance, otherwise the determining unit decides the distance group is a second distance category.

22. The touch control chip of claim 21, wherein the determining unit decides the single finger gesture is a single click gesture if the quantity group is the first quantity category and the distance group is the first distance category.

23. The touch control chip of claim 21, wherein the determining unit decides the single finger gesture is a drag gesture if the quantity group is the second quantity category and the distance group is the first distance category.

24. The touch control chip of claim 21, wherein the determining unit decides the single finger gesture is a double click gesture if the quantity group is the third quantity category and the distance group is the first distance category.

25. The touch control chip of claim 21, wherein the determining unit decides the single finger gesture is a flip gesture if the quantity group is the first quantity category and the distance group is the second distance category.

26. The touch control chip of claim 21, wherein the determining unit decides the single finger gesture is a jump gesture if the quantity group is the third quantity category and the distance group is the second distance category.

27. A touch control system, comprising:
a touch sensing device, for generating one or more signal values of one or more detecting signals; and
the touch control chip of claim 14, for determining a single finger gesture according to the one or more signal values of the one or more detecting signals generated by the touch sensing device.

28. A computer system, comprising:
the touch control system of claim 27, for determining a single finger gesture; and
a host, for receiving a packet of the single finger gesture from the touch control system.
